(19) United States
(12) Patent Application Publication
(10) Pub. No.: US 2013/0282581 A1
(43) Pub. Date: Oct. 24, 2013

(54) MOBILE DEVICE-BASED CARDLESS FINANCIAL TRANSACTIONS

(71) Applicant: INFOSYS LIMITED, Bangalore (IN)

(72) Inventor: Alok Singh, Ghatsila (IN)

(73) Assignee: INFOSYS LIMITED, Bangalore (IN)

(21) Appl. No.: 13/864,164

(22) Filed: Apr. 16, 2013

(30) Foreign Application Priority Data
Apr. 18, 2012 (IN) 1536/CHE/2012

(51) Int. Cl. G06Q 20/32

(52) U.S. Cl. CPC G06Q 20/322
USPC 705/44

(57) ABSTRACT

The technologies disclosed herein use mobile computing devices, such as smartphones, to facilitate purchases without the use of a credit or debit card (i.e., “cardless” purchases). A cardless purchase can be initiated by a user using their mobile device to connect with a merchant's acquiring bank (acquirer), the acquirer collecting a mobile device identifier (e.g., phone number), an issuer code, a merchant code, account security information (e.g., a card security code and an access code), and the acquirer sending a request to the user's issuing bank to authorize the purchase. The acquirer uses the information received from the mobile device to assemble an account number, typically 15 or 16 digits long, so as to leverage existing acquirer, issuer and credit card network infrastructure. Upon receiving a response from the issuer bank, the user and merchant are notified (via SMS, email or other method) whether the transaction has been authorized.

### CROSS REFERENCE TO RELATED APPLICATION

This application claims the benefit of Indian Patent Application No. 1536/CHE/2012, filed Apr. 18, 2012, which is incorporated herein by reference.

### BACKGROUND

Physical credit and debit cards are ubiquitous in modern life, relied upon by both consumers and merchants to facilitate the purchase and sale of a myriad of goods and services. With the widespread adoption of intelligent mobile devices, such as smartphones and tablet computers, efforts have been made to utilize these devices as an additional platform for facilitating commerce. These efforts include the development of portable card readers that can be inserted into mobile devices, and enabling mobile device and point of sale terminals with Near Field Communication (NFC) technology.

### SUMMARY

This Summary is provided to introduce a selection of concepts, in a simplified form, that are further described hereafter in the Detailed Description. This Summary is not intended to identify key features or essential features of the claimed subject matter nor is it intended to be used to limit the scope of the claimed subject matter.

Technologies are disclosed that allow purchases to be made using a mobile computing device, such as a smartphone, in place of a credit or debit card. Instead of a financial account linked to a physical card, the account is linked to a mobile computing device. Instead of having merchants initiate financial transaction, the transactions are initiated by a consumer.

In one embodiment, in order to make a cardless purchase, a merchant provides a user with a merchant code and the phone number of an interactive voice response (IVR) system of the merchant's acquirer. The user calls the IVR system using his or her mobile device, and uses the IVR to initiate a financial transaction. The IVR system prompts the user for the merchant, a transaction amount, an issuer code (associated with the bank that issued the financial account linked to the mobile phone) and account security information. The IVR system also obtains a mobile computing device identifier. Typically, the mobile device's phone number is used as the mobile computing device identifier, which the IVR system can obtain automatically as a part of the receiving a call from the mobile device.

The acquirer computer system, of which the IVR system is a part, generates an account number based on the mobile computing device identifier and the issuer code. The acquirer computer system sends a financial transaction authorization request to an issuer computer system and in response receives an indication of whether the authorization request has been approved. Notifications are sent to the user and the merchant to inform the parties whether the user-initiated financial transaction has been approved.

In some embodiments, the account number can be a 15- or 16-digit number, allowing existing acquirer, issuer and credit card network infrastructure to be leveraged. Further, the account security information collected from the user can comprise a card verification value (CVV) code of the type currently used on physical credit and debit cards (e.g., the ubiquitous 3-digit code on the back of some cards) and, optionally, a 3-D Secure access code.

In various embodiments, if the acquirer computer system determines that it is the same entity as the issuer associated with the financial account linked to the mobile computing device, the acquirer computer system not prompt the user to provide an issuer code, as this information is already known to the acquirer.

The foregoing and other objects, features and advantages of the disclosed technologies will become more apparent from the following detailed description, which proceeds with reference to the accompanying figures.

### BRIEF DESCRIPTION OF THE DRAWINGS

FIG. 1 is a block diagram illustrating a system for facilitating cardless financial transactions.

FIG. 2 illustrates an exemplary financial account number for a cardless account.

FIG. 3 illustrates an exemplary usage scenario in which a user makes a purchase via a cardless financial transaction.

FIG. 4 is a flowchart of an exemplary method of authorizing a cardless financial transaction.

FIG. 5 is a flowchart of an exemplary method of making a cardless financial transaction request.

FIG. 6 illustrates a generalized example of a suitable computing environment in which described embodiments, techniques and technologies can be implemented.

### DETAILED DESCRIPTION

The technologies disclosed herein utilize mobile computing devices, such as smartphones, to facilitate financial transactions without the use of a credit or debit card. Rather than linking a financial account to a physical card, a financial account is linked to a mobile device. Facilitating a cardless financial transactions comprise a user using his or her mobile device to connect with a merchant's acquiring bank (acquirer) and supplying information requested by the acquirer. The acquirer generates an account number based on the received information and with the mobile device phone number, and uses existing acquirer, issuer and credit card network infrastructure to authorize the transaction. The user and the merchant are notified via Short Message Service (SMS), email, etc. by the acquirer whether the financial transaction has been authorized.

### Example 1

### Exemplary Cardless Financial Transaction System

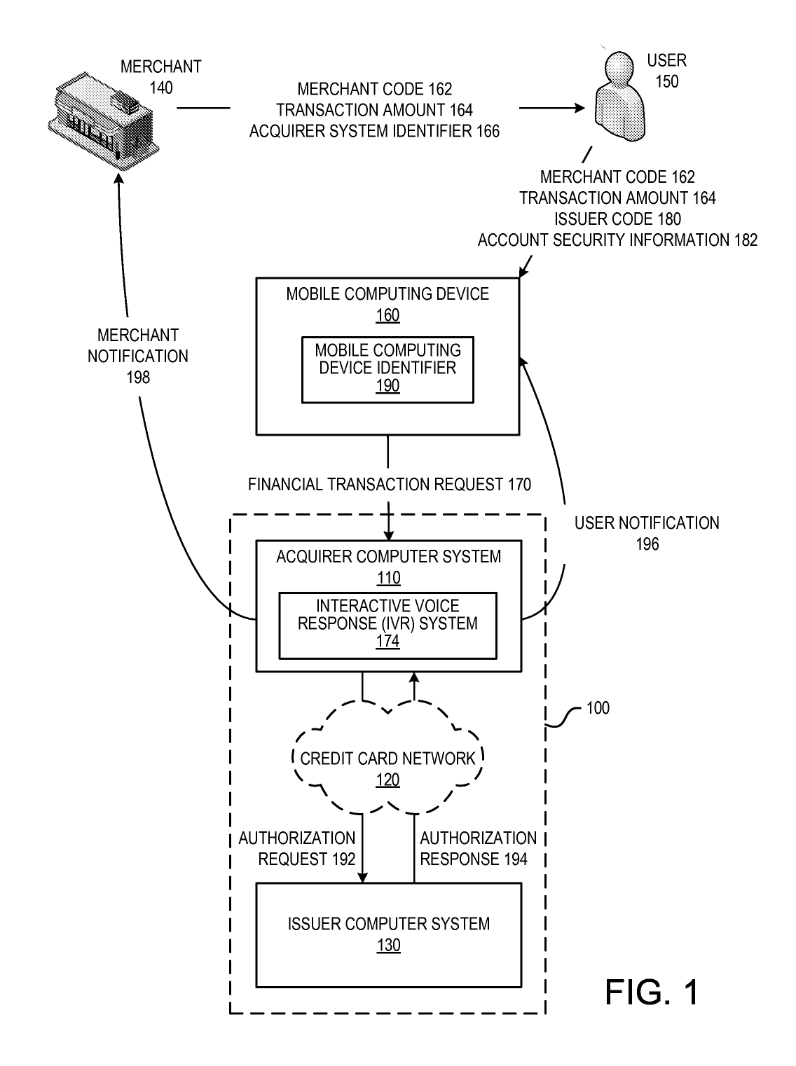

FIG. 1 is a block diagram illustrating a system 100 for facilitating cardless financial transactions. The system 100 comprises an acquirer computer system 110, a credit card network 120 and an issuer computer system 130. The system 100 interacts with a merchant 140 and a mobile computing device 160. A user 150 interacts with the merchant 140 and the mobile computing device 160.

The merchant 140 can be any entity, such as a person or business, offering goods and/or services that the user 150 wishes to purchase. In the cardless system 100, financial transactions are initiated by users rather than merchants. Thus, rather than the merchant 140 receiving financial account information from the user 150 to initiate a financial transaction (i.e., in the form of a credit or debit card), the merchant 140 supplies information to the user 150. The merchant-supplied information comprises a merchant code 162, a transaction amount 164 and an acquirer computer system identifier 166.

The user 150 initiates a financial transaction by using the acquirer computer system identifier 166 to contact the acquirer computer system 110 with the mobile computing device 160. Typically, the acquirer computer system identifier 166 is a phone number. Once connected, the user 150 makes a financial transaction request 170. In one example, the acquirer computer system identifier 166 is a phone number for an interactive voice response (IVR) system 174, and the user initiates the transaction request by selecting an “initiate financial transaction” option (or equivalent) from an IVR menu. As part of initiating a financial transaction request, the user 150 provides the merchant code 162, the transaction amount 164, an issuer code 180 and account security information 182 to the acquirer computer system 110 via the mobile computing device 160. This information can be supplied by the user 150 in response to one or more prompts provided by the IVR system 174.

The mobile computing device 160 can be any of a variety of mobile computing devices including mobile devices such as cell phone, smartphone, handheld computer, laptop computer, notebook computer, tablet device, slate device, Personal Digital Assistant (PDA), etc. that allows for wired or wireless communication with one or more networks, such as a Wi-Fi, cellular or satellite network. The mobile computing device 160 stores a mobile computing device identifier 190 that is supplied to the acquirer computer system 110 as part of the financial transaction request 170. Typically, the mobile computing device identifier 190 is a mobile phone number of the mobile computing device 160, which is automatically supplied to the acquirer computer system 110 as a result of the device 160 calling the system 110. Alternatively, the mobile computing device 160 can be supplied by the user 150.

The acquirer computer system 110 (acquirer system) is operated by the acquiring bank or other financial institution that processes credit and debit card payments for the merchant 140. The acquirer system 110 is configured to receive a financial transaction request 170 from a mobile computing device 160. In some embodiments, the financial transaction request 170 can be received at an IVR system 174. The acquirer computer system 140 is further configured to generate an account number from the information provided as part of the transaction request 170. Typically, the account number is generated from the mobile computing device identifier 190 and the issuer code 180. The account number can be a 15- or 16-digit number to conform to existing physical credit card numbering conventions, which allows existing acquirer, issuer and credit card network infrastructure to be leveraged to complete the financial transaction, that is, to authorize and settle the financial transaction. Thus, in some embodiments, little or no changes are required in the credit card networks or issuer computer systems to support the cardless financial transaction technologies described herein.

To authorize the transaction, the acquirer system 110 is configured to submit an authorization request 192 to the issuer computer system 130 associated with the issuer associated with issuer code 180. In general, authorization comprises determining, for example, verifying the account (e.g., determining that the provided account security information (e.g., card security code and access code) matches that stored in the records of the issuer computer system 130 for the supplied account number), and that the account has enough remaining credit or debit balance to cover the transaction amount. The acquirer computer system 110 is further configured to, upon receipt of an authorization response 194 from the issuer computer system 130, to send a user notification 196 to the user 150 and a merchant notification 198 to the merchant indicating whether the requested financial transaction has been approved or denied. Typically, the user notification 196 is sent to the mobile computing device 160 and the merchant notification 198 is sent to a merchant computing device (not shown).

The issuer computer system 130 (issuer system) is operated by the issuing bank or financial institution associated with the financial account (e.g., a line of credit or a debit card account) linked to the mobile computing device 160 and which is to be used for the financial transaction. The issuer computer system 130 can be accessed by the acquirer computer system 110 through the credit card network 120. Although one network and one issuer computer system is shown in FIG. 1, acquirer computer systems are generally capable of submitting authorization requests to various issuer computer systems via various networks. Once a transaction has been authorized, the acquirer and issuer settle the transaction according to known procedures.

### Example 2

### Exemplary Merchant-Provided Information

In any of the examples described herein, the merchant code and the acquirer computer system identifier can have any of the following characteristics. A merchant code (or service establishment number) is assigned to a particular merchant by an acquirer and the acquirer computer system identifier can be any identifier, such as a phone number or a URL (Uniform Resource Locator), that a mobile computing device can use to connect to an acquirer's computer system. If the acquirer computer system identifier is a phone number, the phone number can be a toll-free number or any other number that results in a customer incurring zero or little cost to connect to an acquiring computer system. An acquirer computer system can have multiple phone numbers associated with it in order to, for example, accommodate heavy call traffic or to allow customers in other countries to access the acquirer system via a local call and avoid international call charges. The merchant code (as well as any other code described herein) can be numeric, alphanumeric or any other type code.

The merchant code, transaction amount and acquirer computer system identifier can be supplied to a user in various ways. For example, the merchant code and the acquirer computer system identifier can be displayed in a merchant's place of business, on their web site, or listed on a bill presented to a user. The information can be in human-readable form that the user then enters into the mobile device. The information can be alternatively or additionally presented in a machine-readable form, such as in a one- or two-dimensional bar code (e.g., a Quick Response (QR) code) that the mobile device can receive at a video input device and extract information therefrom. In various embodiments, the mobile device can be configured to extract the merchant-provided information from an image of a bill captured by the mobile device. In some embodiments, a mobile device application configured to interpret a bar code can cause the mobile device to be automatically connected to the acquirer bank's computer system to initiate a financial transaction upon extracting the acquirer system's URL from the code. Further, the merchant can send the merchant code, transaction amount and acquirer computer system identifier to the mobile computing device from a merchant computing device via SMS, MMS or via a message sent via short-range wireless technologies such as Bluetooth or Near Field Communication (NFC).

In various examples, if the mobile computing device is GPS-enabled, the merchant code can be determined automatically based on the mobile device's location. For example, the merchant code can be extracted based on location data from a locally stored look-up-table or by sending the device's location as part of a merchant code identification request to a remote server, and receiving a merchant code in response.

In some embodiments, additional security can be provided by presenting an encrypted merchant code to a user. The acquirer computer system can be configured to decrypt the merchant code before sending an authorization request. For example, an encrypted merchant code 987654321 can be mapped to an unencrypted merchant code of 123456789. In some embodiments, merchant codes are assigned sequentially by an acquirer, meaning that an error by a user in entering a merchant code into a mobile computing device can cause a requested transaction to fail as the requested transaction is identified as being for another merchant. Encryption of merchant codes can help overcome user data entry errors to an extent. In various embodiments, the encrypted merchant code can be decrypted by a software application provided by the acquirer and executing on the mobile device to generate a decrypted merchant code that is provided to the acquirer. Thus, only mobile devices having the acquirer-provided software application installed can properly decrypt encrypted merchant codes.

### Example 3

### Exemplary Financial Account Information

In any of the examples described herein, financial account information, which comprises mobile computing device identifiers, issuer codes and account security information can have any of the following characteristics.

When a user establishes a cardless credit or debit account with an issuing bank or other financial institution, the issuer provides the user with an issuer code specific to the issuer, and assigns account security information to the account. The account security information can comprise a card security code. The account security information can further include an access code. In order to allow existing acquirer and issuer infrastructure to be used with the cardless transaction technologies described herein, the card security code and the access code can be of a type used with physical credit cards. For example, the card security code can be a Card Verification Value (CVV) code such as a CVV1 code (e.g., the code embedded in the magnetic strip on the back of a physical credit card used for in-person purchases), or a CVV2 code (e.g., a security found on the front or back of physical credit cards used for “card not present” transactions, such as online transactions). In addition, the access code can be a 3-D Secure access code used with physical credit and debit cards for online transactions, and typically comprising a string of keyboard characters. In some embodiments, the access code is a 4-digit number. Typically, as there is no physical card associated with a cardless account as described herein, no expiration date is associated with the account.

The issuer code can be a numeric, alphanumeric or other type of code that can be entered (e.g., by voice or manually) by a user into a mobile computing device, or provided by a mobile computing device to an acquirer computer system, independent of user input. Typically, the issuer code is a 6-digit numeric code.

The mobile computing device identifier is an identifier supplied by the user to the issuer upon a cardless account that the user wishes to be associated with the financial account. Typically, the mobile computing device identifier is a mobile device phone number, but the mobile computing device identifier can be based on any information stored at the mobile device. Such information includes an International Mobile Subscriber Identity (IMSI) that uniquely defines a mobile operator subscriber (stored on a GSM (Global System for Mobile) Subscriber Identity Module (SIM) smart card (SIM card)); a Mobile Subscription Identification Number (MSIN), which identifies a subscriber for a given mobile operator or an Integrated Circuit Card Identifier (ICCID), which is the serial number of the SIM card; a GSM device's International Mobile Equipment Identifier (IMEI); or an electronic Serial Number (ESN) or a Mobile Equipment Identifier (MEID) that uniquely identifies a CDMA (Code Division Multiple Access) phone. The mobile phone device identifier can be based on any one of these pieces of information or combinations thereof.

### Example 4

### Exemplary Financial Account Number

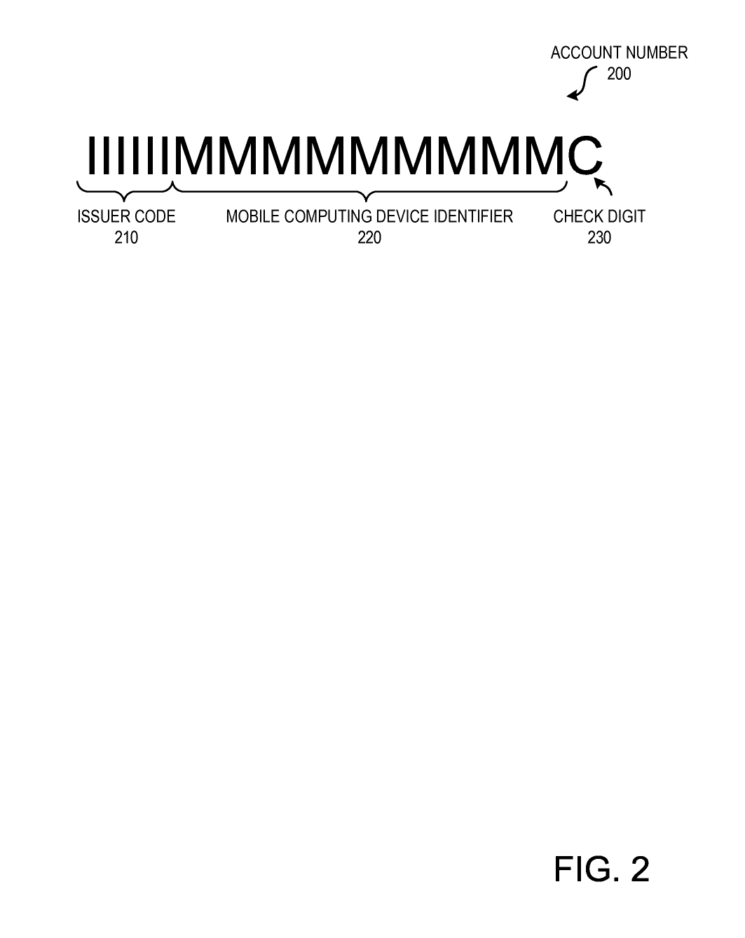

FIG. 2 shows an exemplary financial account number 200 for the cardless accounts described herein. The account number 200 is a 16-digit number comprising a six-digit issuer code 210, a nine-digit mobile computing device identifier 220 (which can be a mobile phone number) and a check digit 230 used to validate the authenticity of the account number 200. The account number 200 shown in FIG. 2 is just one way an account number can be assembled and many other variations are possible. For example, the check digit 230 can be left off the account number, leaving a 15-digit account number. Further, the components of the account number can be rearranged or mixed (e.g., the mobile computing device identifier could be on the left, or individual issuer code digits could be interspersed among the mobile device identifier digits), or comprise more or fewer digits. Using an account number of 15- or 16-digit makes the cardless account number length match that of conventional credit card accounts, thereby allowing for reuse of credit card system infrastructure.

In some embodiments, a mobile computing device identifier can be mapped to account numbers to increase security. In this manner, security can be enhanced, as a person desiring to make a fraudulent transaction would need to know not only another user's mobile phone number, but also the mapping used by the acquirer computer system to generate the account number from the mobile device identifier.

### Example 5

### Exemplary Connections of Mobile Computing Devices to Acquirer Computer Systems

In any of the examples described herein, a mobile computing device can connect to an acquirer computer system in any of following manners. In one embodiment, a mobile computing device can call an acquirer bank phone number provided to a user by a merchant to connect to an acquirer's computer system.

In some embodiments, an acquirer computer system identifier connects the mobile device to an IVR system. The user can invoke an “initiate financial transaction” IVR option (or equivalent) to start a financial transaction, and follow IVR system prompts to supply information such as the issuer code, merchant code, account security information, and transaction amount. The IVR system can automatically detect the mobile phone number of the mobile computing device using known methods. If a mobile phone number is the mobile device identifier, automatic detection of the phone number provides security advantages as the mobile device tied to a financial account to be used in a transaction must be the device from which a transaction is initiated. That is, even if a person wishing to make a fraudulent transaction has knowledge of the mobile phone number (or other mobile device identifier) tied to a financial account, that person must also be in possession of the mobile device to make the fraudulent transaction. Even with possession of a mobile device and an account's card security code (and, access code, if one has been assigned to an account), information that is generally kept secret by a user, must be known before a transaction is made.

In some embodiments, the user can submit a financial transaction request via a Short Message Service (SMS) message in which the issuer code, transaction amount, merchant code, card security code (and, optionally, an access code) are “texted” to an acquirer computer system. The information could be provided to an acquirer system one field at a time, or in a single text with the fields separated by a delimiter (e.g., a space, pound sign, underscore character). The acquirer computer system can send a response text to the mobile computing device indicating whether the requested transaction has been approved or declined.

In some embodiments, the mobile device can connect to the acquirer computer system via a network connection (e.g., the Internet). For example, a user can invoke a software application stored on the mobile device that operates to connect the mobile device to the acquirer computer system. In some embodiments, a mobile device application can collect the information needed to initiate a financial transaction (e.g., issuer code, merchant code, transaction amount, card security code, access code) from the user via a user interface, and, once the information is collected, cause the mobile device to connect to the acquirer computer system, and submit the collected information to initiate the transaction.

As already mentioned, the merchant-supplied information could be automatically captured by the mobile device (e.g., via QR code, image recognition) to avoid a user having to manually enter the information into the mobile device. However, to increase security, in various embodiments, the mobile device can be configured to query the user for the needed financial account information (e.g., issuer code, card security code, access code) when a transaction is made, regardless of whether this information is stored locally at the mobile computing device. Thus, in such embodiments, even if the mobile device is lost or stolen, the mobile device cannot be used to make unwanted transactions as the card security code and access code are generally not known to people other than the mobile device user. In other embodiments, this financial account information is stored at the mobile device and provided to the acquirer system automatically.

The technologies described herein can allow a user to initiate a financial transaction with a low amount of user interaction with the device. For example, a merchant can supply a bill to a user in which the merchant code, transaction amount, and acquirer computer system identifier is embedded within a QR code. The mobile device can read and interpret the QR code, automatically connect the mobile device to the acquirer system, automatically submit both the merchant-supplied information and the financial account information stored locally at the device, and initiate the financial transaction automatically.

In some embodiments, the mobile device rather than the acquirer computer system generates the account number and the mobile device sends the account number to the acquirer computer system as part of the financial transaction request.

### Example 6

### Exemplary User and Merchant Notifications

In any of the examples described herein, the acquiring computer system can send notifications to the user and merchant that a requested financial transaction has been approved or declined. These notifications can be sent by an acquirer computer system upon receipt of an authorization confirmation from an issuer computer system (in the case of an onus-offus transaction), or upon determination by the acquirer system that the transaction is authorized (in the case of an onus-onus transaction).

The notifications can be sent via SMS, MMS (Multimedia Messaging Service), email, automated phone call, social media network, or any other method that causes the notification to appear, for the user, at the mobile computing device, and, for the merchant, at any merchant computing device, such that the merchant and user can confirm whether a user-initiated financial transaction has been approved or denied. The merchant computer device can be a point of sale terminal, smartphone, tablet computer, laptop, or other computing device capable of receiving a notification. The user and merchant notifications need not be made in the same manner. For example, the user can be notified of authorization via a SMS message and the merchant can be notified via an email message. Further, multiple notifications to the user or merchant can be made. For example, a user may wish to receive both a text message and an email notification that a transaction has been authorized.

If the user wishes to be notified in a manner other than by SMS or MMS message, such as by email, the acquirer system is to be provided with the appropriate information (e.g., a user's email address). This information can be provided to the acquirer computer system as part of the financial transaction request, already stored at the acquirer computer system (for an onus-onus transaction), or provided to the acquirer system by the issuer as part of the authorization response (for an onus-offus) transaction.

The merchant computing device can be any mobile or non-mobile computing device (e.g., smartphone, cell phone, laptop, tablet computer, desktop computer) capable of receiving notifications from a remote acquirer computer system. The merchant computing device to which merchant notifications are to be sent can be determined when the merchant establishes a business relationship with the acquirer or at any subsequent time. The merchant can supply a phone number, email address, social media account network information, or any other information by which the merchant can be notified whether a customer's financial transaction is authorized. In some embodiments, a merchant computing device's phone number or email address to which a merchant notification is to be sent can be embedded in a QR code (or other code) and provided by the mobile computing device to the acquiring computer system as part of the financial transaction request.

### Example 7

### Exemplary Onus-Onus Transaction

The technologies described herein can be used to handle onus-onus transactions, wherein the acquirer and the issuer are the same entity (as opposed to onus-offus transactions, wherein the acquirer and issuer are different entities). In onus-onus transactions, the acquirer computer system does not need to collect an issuer code from a user as the acquirer is also the issuer and thus knows the issuer code. This can allow for quicker initiation of a financial transaction by a user as the user is not prompted to enter the issuer code.

An acquiring computer system can determine that the issuer associated with the financial account tied to a particular mobile computing device is the same entity as the acquirer based on, for example, the mobile computing device identifier. For example, the acquirer system can maintain a database of mobile computing device identifiers associated with financial accounts for which the acquirer is also the issuer. If a provided mobile computing device identifier matches an identifier in the database, the acquirer computer system knows that the acquirer is also the issuer. In some embodiments, an acquirer IVR system can be configured to query the user whether the user's issuer bank is the same entity as the acquirer. For example, when querying the user for an issuer code, the IVR system can ask, for example, “Please enter your six digit issuer code. Press zero your account was issued by XXX bank” (where XXX is the name of the issuer bank). Thus, a user is spared from having to enter a six-digit issuer code and only needs to press one number in order in an onus-onus transaction.

### Example 8

### Exemplary Usage Scenario

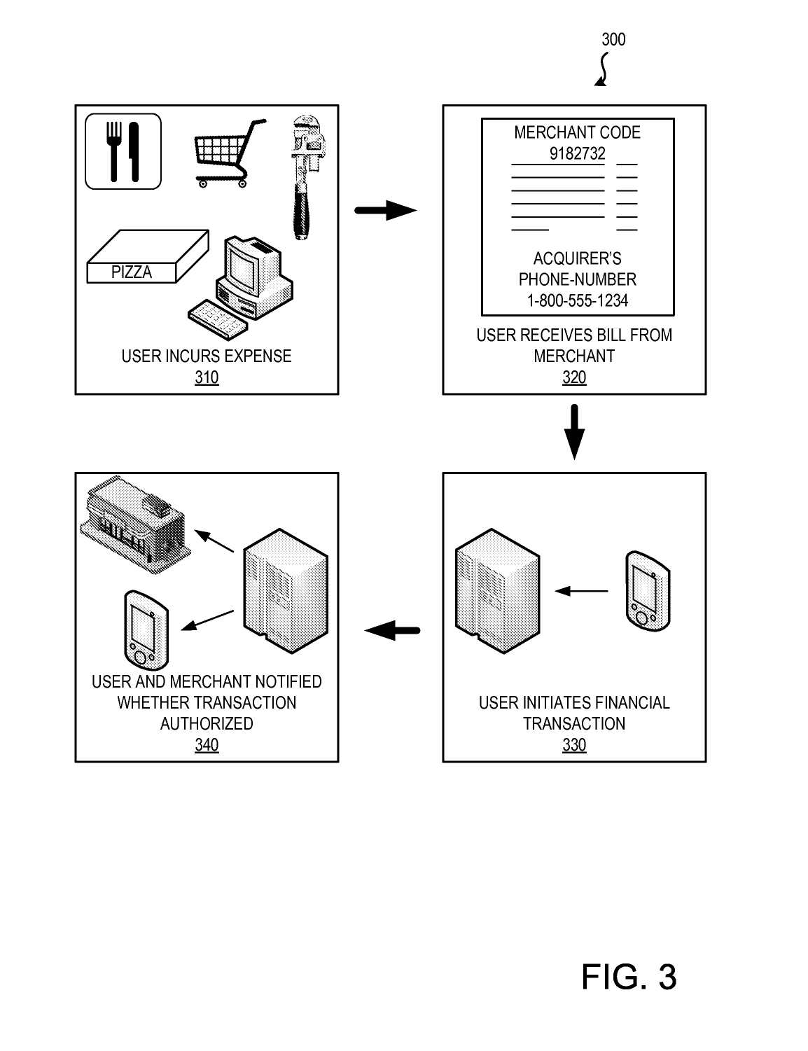

FIG. 3 illustrates an exemplary usage scenario 300 in which a user makes a purchase via a cardless financial transaction. First, a user incurs an expense (310). For example, a user can have finished dining at a restaurant, have pizza deliveryman standing on his doorstep waiting to be paid, have a plumber or other tradesman finish providing a service, have goods rung-up at a store's point of sale, or ready to pay for items collected in an online merchant's virtual shopping cart.

Second, the user receives the bill (either in person or online) from the merchant (320). The bill contains a merchant code and a phone number for an acquirer's IVR system that the user can call to initiate a financial transaction request to pay the bill.

Third, the user calls the acquirer's IVR system with his or her mobile device to initiate the financial transaction (330). The IVR system determines the user's mobile phone number from the call, and prompts the user to enter a card validation code, the merchant code, the transaction amount, an issuer code and an access code.

Fourth, the acquirer computer system sends an authorization request to an issuer computer system operated by the issuer associated with the issuer code, receives an authorization confirmation from the issuer computer system, and sends notifications to the user's mobile device and the merchant that the financial transaction initiated by the user has been authorized (340).

### Example 9

### Exemplary Online Usage Scenarios

In two exemplary scenarios, an online merchant can facilitate a cardless financial transaction as follows. In a first exemplary scenario, at an online merchant's website, a user places items in his or her virtual shopping cart and proceeds to the online payment web page to finish shopping. On the payment page, a merchant code and an acquirer computer system identifier (e.g., a local acquirer computer system toll-free phone number) is shown. The user is offered the option to purchase the items via a cardless financial transaction using their mobile computing device and is prompted to enter their mobile device phone number M1 on the online screen. The online merchant then receives notification at a merchant computing device that a financial transaction initiated using a mobile computing device with mobile device number M2 has been authorized for the transaction amount. The online merchant compares M1 to M2, and, if they are the same, displays a notice that the merchant has received notification that the cardless transaction has been authorized.

In a second exemplary scenario, the merchant computer system operating an online store (online merchant) receives an indication that a user wishes to purchase goods and/or services from the online merchant for a transaction amount. The online merchant sends a merchant code, the transaction amount, and an acquirer computer system identifier to a client computing device, such as any mobile computing device described herein. The client computing device is the computing device that the user is using for online shopping. The merchant code, the transaction amount and the acquirer computer system identifier (typically a phone number) is displayed at a display of the client computing device. The online merchant then receives a notification from an acquirer computer system that a financial transaction for the transaction amount to pay for the goods and/or services with a financial account linked to the user has been authorized.

### Example 10

### Exemplary Method of Authorizing a Cardless Purchase Transaction

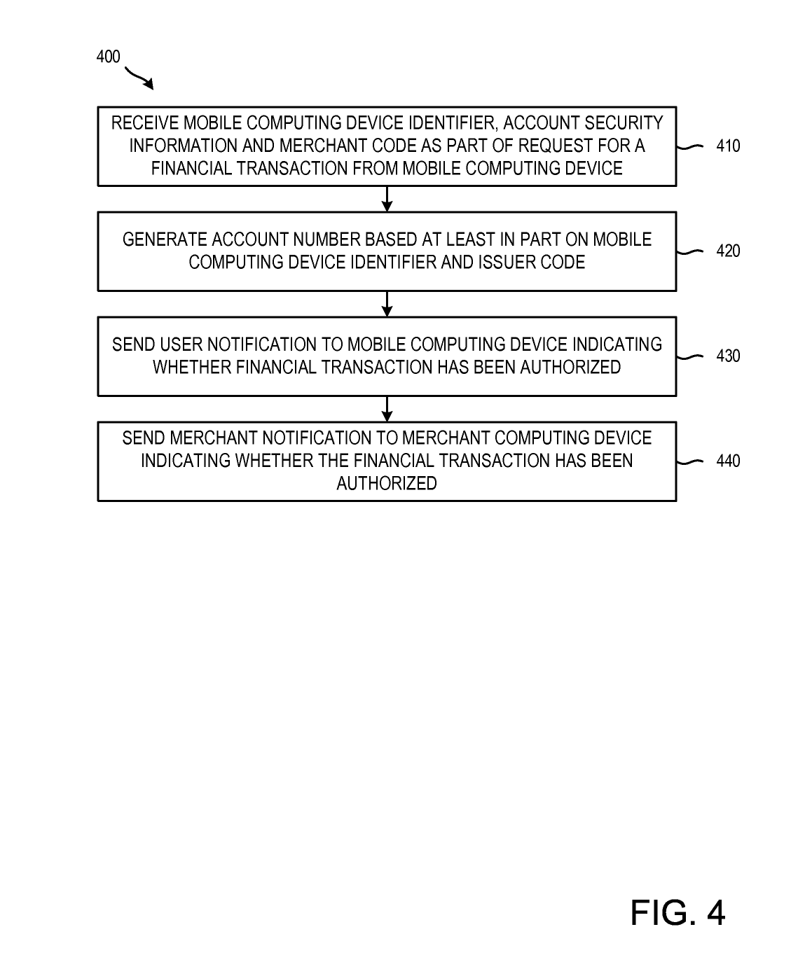

FIG. 4 is a flowchart of an exemplary method 400 of authorizing a cardless financial transaction. The method 400 can be performed by, for example, an acquirer computer system comprising an IVR system that has been called by a user's smartphone to initiate a financial transaction to pay for a user's dinner at his favorite restaurant. A phone number for the IVR system of the merchant's acquiring bank is provided to the user on the restaurant bill, along with the restaurant's merchant code. The financial transaction is an onus-onus transaction as the issuer associated with the account linked to the user's smartphone is the same as the restaurant's acquiring bank.

At process block 410, a mobile computing device identifier and a merchant code are received at an acquirer computer system from a mobile computing device as part of a request for a financial transaction. In the example, the user requests a cardless financial transaction through the IVR menu. The IVR system prompts the user for the merchant code of the restaurant. The user supplies this information to his smartphone, and the information is received by the IVR system. The IVR system automatically detects the 9-digit mobile phone number of the user's smartphone and does not prompt the user for this information.

At process block 420, an account number is generated based at least in part on the mobile computing device identifier and an issuer code. In the example, the acquirer computer system generates a 16-digit account number based by concatenating a 6-digit issuer code (which is known to the acquirer, as it is also the issuer for this particular onus-onus transaction), the detected 9-digit mobile phone number and a check digit.

At process block 430, the financial transaction is authorized based on at least the account number.

At process block 440, a user notification is sent to the mobile computing device indicating whether the financial transaction request has been authorized. In the example, the acquirer computer system sends an SMS message to the user's smartphone indicating whether the financial transaction request has been authorized.

At process block 450, a merchant notification is sent indicating whether the financial transaction request has been authorized. In the example, the acquirer computer system sends an email to the merchant at an email address stored in a record in an acquirer's database associated with the merchant.

The method 400 can comprise additional steps. For example, if the acquirer and issuer are different entities, the method 400 can further comprise receiving account security information at the acquirer computer system from the mobile computing device as part of the request for the financial transaction. The authorization can comprise sending an authorization request that the financial transaction be authorized to an issuer computer system associated with the issuer code, the authorization request comprises the account number; and receiving an indication from the issuer computer system whether the authorization request has been approved is then received. In additional embodiments, the method 400 can further comprise receiving the issuer code from the mobile computing device.

In other embodiments, where the requested financial transaction is an onus-onus transaction, the method 400 can further comprise receiving account security information at the acquirer computer system from the mobile computing device as part of the request for the financial transaction. In this situation, the authorization can comprise, at the acquirer computer system, authorizing the financial transaction based on at least the account number, the account security information and a transaction amount; wherein the acquirer computer system approves the authorization request.

### Example 11

### Exemplary Method of Making a Cardless Financial Transaction Request

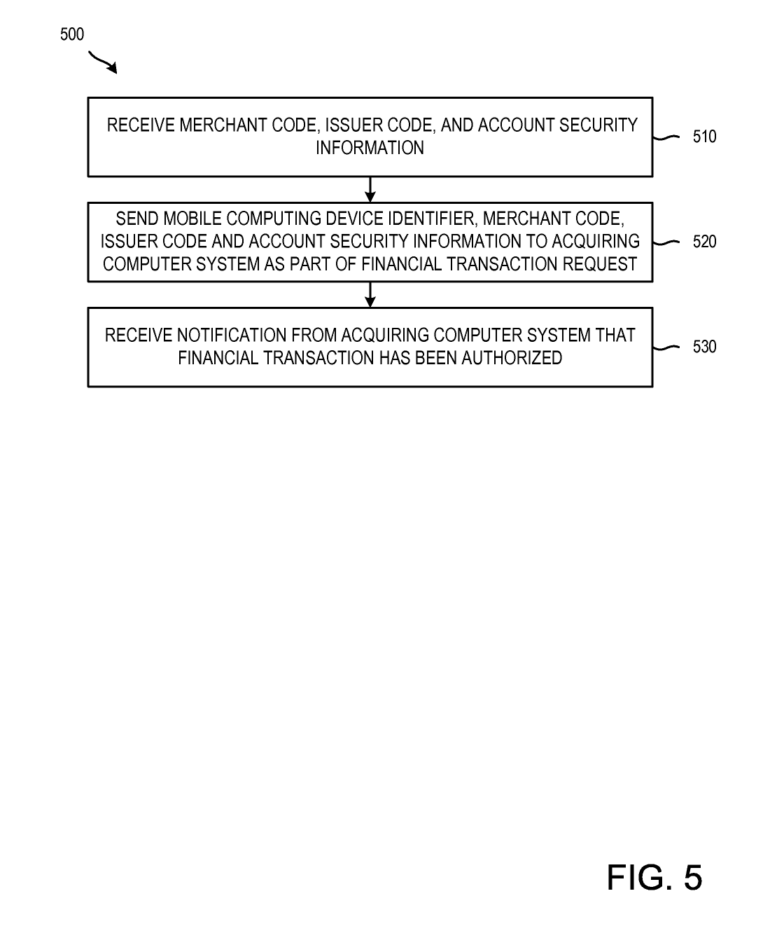

FIG. 5 is a flowchart of an exemplary method 500 of making a cardless financial transaction request. The method 500 can be performed by, for example, a mobile phone that has connected to a merchant's acquirer's IVR system in order for a user to initiate a financial transaction request to purchase items from on online retailer.

At process block 510, a merchant code, issuer code and account security information are received from a user. In the example, the mobile phone receives the online retailer's merchant code (which can be provided to the user via an output display of a computing device on which the user is doing his or her online shopping (e.g., the mobile phone, a laptop computer)), the CVV code associated with the financial account linked to the mobile phone to be used for paying for the online goods or services, and the issuer code of the issuer associated with the financial account. The information can be received from the user in response to one or more prompts provided by the IVR system to the user.

At process block 520, a mobile computing device identifier stored at the mobile computing device, the merchant code, the issuer code and the account security information are sent to an acquirer computer system. In the example, the mobile phone sends the online merchant's merchant code, an issuer code, the CVV code, along with the smartphone's mobile phone number to the IVR system as part of a financial transaction request. The mobile phone number can be automatically detected by the IVR system as a result of the smartphone placing a call to the IVR system.

At process block 530, notification from the acquiring computer system is received indicating whether the financial transaction request has been authorized. In the example, the smartphone receives a SMS message from the acquirer computer system of which the IVR system is a part.

### Exemplary Advantages

The cardless financial transaction technologies disclosed herein have at least the following advantages. Being able to execute financial transactions without a physical card or card-reading hardware (e.g., magnetic strip reader, NFC-enabled POS terminals) means that cardless financial transactions can be initiated by a user at any time and at any place where mobile phone services are available. Further, users do not need to wait to receive a physical card from an issuing bank (which can take a week or longer) and there is no card for a user to lose or have stolen. In addition, the lack of a physical card means that a user does not have to temporarily hand over control of his account information to the merchant in order to complete a financial transaction (e.g., handing a credit card over to a waiter), thus keeping financial account information more secure.

From an issuer's perspective, expenses are reduced by not having to create and mail new and replacement cards to users. Moreover, in scenarios where the account information is 15 or 16 digits long, alterations to credit card networks and to issuer bank computer systems are not needed (or are at least minimal). Acquirer computer system modification can comprise those needed to support receiving a user-initiated cardless financial transaction, generating an account number from a mobile computing device identifier and issuer code. Using card security codes like CVV1 and CVV2 codes and access codes like 3-D Secure codes also increases infrastructure reuse. In some embodiments, an acquirer computer system can be adapted to support the technologies described herein by adding an option to an existing IVR system that allows a user to initiate a financial transaction.

A merchant's costs can be reduced by using the technologies described herein as a merchant does not need to purchase (or can purchase fewer) point of sale devices capable of reading credit or debit cards or upgrade to newer POS devices employing new mobile technologies (e.g., NFC-enabled POS devices). A merchant can offer cardless transactions to consumers as soon as the merchant enters into a business relationship with an acquirer that supports cardless transactions, and is assigned a merchant code. There is also less dependency on communications infrastructure. A merchant's ability to make a sale is not lost if their POS terminals lose connectivity with acquirer computers systems, and mobile telephone services are still available.

From a user's perspective, mobile-device facilitated cardless transactions offer increased flexibility in making purchases. For example, if a user in a brick-and-mortar store fills up a shopping cart with items and the store is unable to connect to its acquiring bank because of, for example, a network outage, the user can still complete his or her purchase by initiating a cardless transaction with their mobile device. Even if a merchant's POS terminals are fully functioning, a user may still elect to pay for items via the cardless methods described herein in order to avoid waiting in line.

### Exemplary Computing Environment

The techniques and solutions described herein can be performed by software and/or hardware of a computing environment, such as a computing device. Exemplary computing devices include server computers, desktop computers, laptop computers, notebook computers, netbooks, tablet devices, mobile devices, smartphones and other types of computing devices.

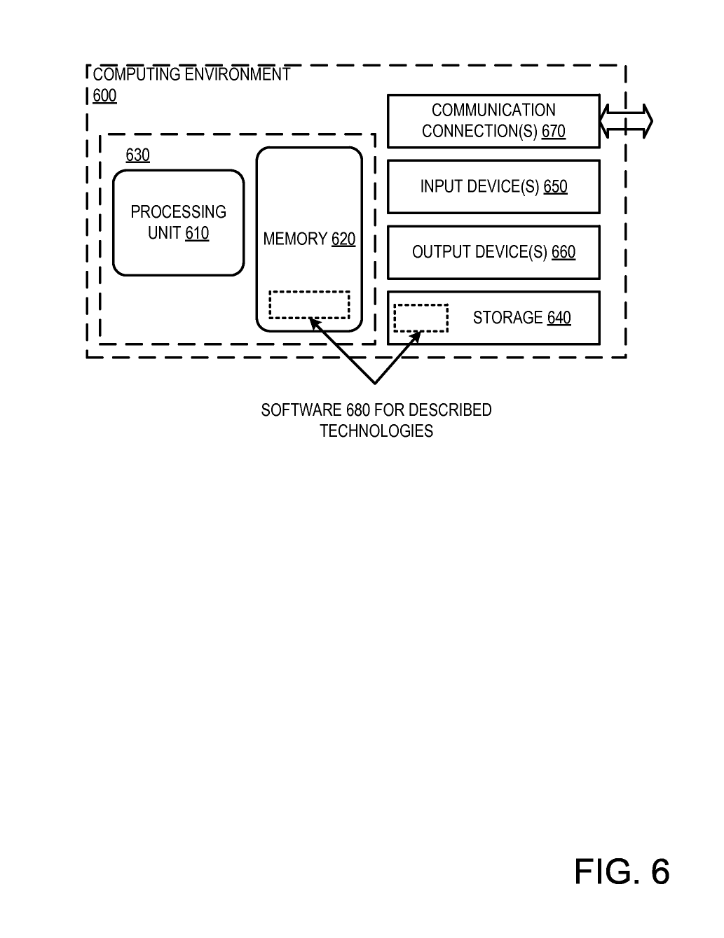

FIG. 6 illustrates a generalized example of a suitable computing environment 600 in which described embodiments, techniques, and technologies can be implemented. The computing environment 600 can correspond to any of the mobile computing devices, merchant computing devices, acquirer computer systems, issuer computer systems and any other computing devices or computer systems described herein. The computing environment 600 is not intended to suggest any limitation as to scope of use or functionality of the technology, as the technology can be implemented in diverse general-purpose or special-purpose computing environments. For example, the disclosed technology can be implemented using one or more computing devices (e.g., a server, desktop, laptop, hand-held device, mobile device, smartphone), respective of the computing devices comprising a processing unit, memory and storage storing computer-executable instructions implementing the technologies described herein. The disclosed technology can also be implemented with other computer system configurations, including multiprocessor systems, microprocessor-based or programmable consumer electronics, network PCs, minicomputers, mainframe computers, a collection of client/server systems and the like. The disclosed technology can also be practiced in distributed computing environments where tasks are performed by remote processing devices that are linked through a communications network, such as the Internet. In a distributed computing environment, program modules can be located in both local and remote memory storage devices.

With reference to FIG. 6, the computing environment 600 includes at least one central processing unit 610 and memory 620. In FIG. 6, this most basic configuration 630 is included within a dashed line. The central processing unit 610 executes computer-executable instructions. In a multi-processing system, multiple processing units execute computer-executable instructions to increase processing power and as such, multiple processors can be running simultaneously. The memory 620 can be volatile memory (e.g., registers, cache, RAM), non-volatile memory (e.g., ROM, EEPROM, flash memory, etc.), or some combination of the two. The memory 620 stores software 680 that can, for example, implement the technologies described herein. A computing environment can have additional features. For example, the computing environment 600 includes storage 640, one or more input devices 650, one or more output devices 660 and one or more communication connections 670. An interconnection mechanism (not shown) such as a bus, a controller, or a network, interconnects the components of the computing environment 600. Typically, operating system software (not shown) provides an operating environment for other software executing in the computing environment 600, and coordinates activities of the components of the computing environment 600.

The storage 640 can be removable or non-removable, and includes magnetic disks, magnetic tapes or cassettes, CD-ROMs, CD-RWs, DVDs, or any other tangible storage medium which can be used to store information and which can be accessed within the computing environment 600. The storage 640 stores instructions for the software 680, which can implement technologies described herein.

The input device(s) 650 can be a touch input device, such as a keyboard, keypad, mouse, touchscreen, pen, or trackball, a voice input device, a scanning device, or another device, that provides input to the computing environment 600. For audio, the input device(s) 650 can be a sound card or similar device that accepts audio input in analog or digital form, or a CD-ROM reader that provides audio samples to the computing environment 600. The output device(s) 660 can be a display, printer, speaker, CD-writer or another device that provides output from the computing environment 600.

The communication connection(s) 670 enable communication over a communication medium (e.g., a connecting network) to other computing entities. The communication medium conveys information such as computer-executable instructions, compressed graphics information or other data in a modulated data signal.

The computing environment 600 can comprise web-based services. For example, the job information or applicant information can be supplied by applicants or employers accessing a web page of a staffing firm. The web page can be accessed, for example, by a mobile device such as a laptop, tablet computer or smartphone, or non-mobile device such as a desktop.

### Methods in Computer-Readable Media

Any of the disclosed methods can be implemented as computer-executable instructions or a computer program product. The computer-executable instructions or computer program products as well as any data created and used during implementation of the disclosed embodiments can be stored on one or more computer-readable storage media (e.g., non-transitory computer-readable storage media, such as one or more optical media discs (such as DVDs or CDs), volatile memory components (such as DRAM or SRAM), or nonvolatile memory components (such as flash memory or hard drives)) and executed on a computer (e.g., any commercially available computer, including smartphones or other computing devices that include computing hardware). Computer-readable storage media does not include propagated signals. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are known in the art are omitted. For example, it is to be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, and infrared communications), electronic communications, or other such communication means.

Any of the methods described herein can be implemented by computer-executable instructions stored in one or more computer-readable storage devices (e.g., hard disk drives, floppy disk drives, memory integrated circuits, memory modules, solid-state drives and other devices comprising computer-readable storage media). Such instructions can cause a computer to perform the method.

### DEFINITIONS

As used in this application and in the claims, the singular forms “a,” “an,” and “the” include the plural forms unless the context clearly dictates otherwise. Similarly, the word “or” is intended to include “and” unless the context clearly indicates otherwise. The term “comprising” means “including;” hence, “comprising A or B” means including A or B, as well as A and B together. Additionally, the term “includes” means “comprises.”

Additionally, the description sometimes uses terms like “produce” and “provide” to describe the disclosed methods. These terms are high-level abstractions of the actual computer operations that are performed. The actual computer operations that correspond to these terms will vary depending on the particular implementation and are readily discernible by one of ordinary skill in the art.

### Alternatives

The disclosed methods, apparatuses and systems should not be construed as limiting in any way. Instead, the present disclosure is directed toward all novel and nonobvious features and aspects of the various disclosed embodiments, alone and in various combinations and subcombinations with one another. The disclosed methods, apparatuses, and systems are not limited to any specific aspect or feature or combination thereof, nor do the disclosed embodiments require that any one or more specific advantages be present or problems be solved.

Theories of operation, scientific principles or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation. In view of the many possible embodiments to which the principles of the illustrated embodiments may be applied, it should be recognized that the illustrated embodiments are only examples and should not be taken as limiting the scope of the disclosure. We claim all that comes within the scope of the appended claims.

We claim:

1. A method of authorizing a cardless transaction, comprising:
receiving at an acquirer computer system from a mobile computing device a mobile computing device identifier and a merchant code as part of a request for a financial transaction;
generating an account number based at least in part on the mobile computing device identifier and an issuer code;
authorizing the financial transaction based on at least the account number;
sending a user notification to the mobile computing device indicating whether the financial transaction has been authorized; and
sending a merchant notification to a merchant associated with the merchant code indicating whether the financial transaction has been authorized.

2. The method of claim 1, further comprising:
receiving account security information at the acquirer computer system from the mobile computing device as part of the request for the financial transaction; and
wherein the authorizing the financial transaction comprises:
sending an authorization request that the financial transaction be authorized to an issuer computer system associated with the issuer code, the authorization request comprising the account number and the account security information; and
receiving an indication from the issuer computer system whether the authorization request has been approved.

3. The method of claim 2, wherein the account security information comprises a card security code.

4. The method of claim 3, wherein the card security code is a card verification value (CVV) code.

5. The method of claim 2, wherein the account security information comprises a 3-D Secure access code.

6. The method of claim 1, further comprising:
receiving account security information at the acquirer computer system from the mobile computing device as part of the request for the financial transaction; and
wherein the authorizing the financial transaction comprises, at the acquirer computer system, authorizing the financial transaction based on at least the account number, the account security information and a transaction amount;
wherein the acquirer computer system authorizes the request.

7. The method of claim 1, further comprising receiving the issuer code from the mobile computing device.

8. The method of claim 1, wherein the acquirer computer system receives the mobile computing device identifier and the merchant code from the mobile computing device as part of a phone call.

9. The method of claim 8, wherein the acquirer computer system comprises an interactive voice response (IVR) system, and the IVR system receives the mobile computing device identifier and the merchant code from the mobile computing device.

10. The method of claim 1, wherein the mobile computing device identifier is a mobile phone number associated with the mobile computing device.

11. The method of claim 1, wherein the mobile computing device identifier is an identifier other than a mobile phone number.

12. The method of claim 1, further comprising: determining that an acquirer associated with the acquiring computer system is the same entity as an issuer associated with a financial account linked to the mobile computing device; and
determining the issuer code based on at least the mobile computing device identifier.

13. One or more computer-readable storage media storing computer-executable instructions for causing the acquiring computer system to perform the method of claim 1.

14. At a mobile computing device, a method comprising:
receiving a merchant code, an issuer code and account security information;
sending a mobile computing device identifier, the merchant code, the issuer code and the account security information to an acquiring computer system as part of a request for a financial transaction; and
receiving notification from the acquiring computer system that the financial transaction has been authorized.

15. The method of claim 14, wherein the merchant code, the account security information, and the issuer code are sent in response to one or more prompts of an interactive voice response (IVR) system.

16. The method of claim 14, further comprising:
receiving an acquiring computer system identifier; and
connecting the mobile computing device to the acquiring computer system using the acquiring computer system identifier.

17. The method of claim 16, wherein the acquiring computer system identifier is a phone number.

18. The method of claim 16, wherein the receiving the merchant code and the acquiring computer system identifier comprises receiving an image at a video input of the mobile computing device and extracting the merchant code and the acquiring computer system identifier from the image; and
in response to the receiving the acquiring computer system identifier, connecting the mobile computing device to the acquirer computer system using the acquiring computer system identifier; and
wherein the sending the issuer code and the account security information is performed without querying a user.

19. One or more computer-readable storage media storing computer-executable instructions for causing the mobile computing device to perform the method of claim 14.

20. A computer system comprising:
a processor;
one or more computer-readable storage media storing instructions for causing the computer system to perform a method, the method comprising:
receiving at an acquirer computer system from a mobile computing device a mobile computing device identifier and a merchant code as part of a request for a financial transaction;
generating an account number based at least in part on the mobile computing device identifier and an issuer code;
authorizing the financial transaction based on at least the account number;
sending a user notification to the mobile computing device indicating whether the financial transaction has been authorized; and
sending a merchant notification to a merchant associated with the merchant code indicating whether the financial transaction has been authorized.

21. A method, comprising:
receiving from a mobile computing device at an interactive voice response (IVR) system, a mobile phone number, an issuer code, a card security code, a merchant code, a 3-D Secure access code and a transaction amount as part of a request for a financial transaction, the IVR system being part of an acquirer computer system;
generating a 15- or 16-digit account number based at least in part on the mobile phone number and the issuer code;
sending to an issuer computer system associated with the issuer code an authorization request that the financial transaction be authorized, the authorization request comprising the account number, the card security code, the transaction amount and the 3-D Secure access code;
receiving an indication from the issuer computer system indicating whether the authorization request has been approved;
sending a user notification to the mobile computing device that the financial transaction has been approved; and
sending a merchant notification to a merchant computing device indicating that the financial transaction has been approved.

22. A method of facilitating a cardless financial transaction, the method comprising:
receiving an indication that a user wishes to purchase goods and/or services from an online merchant for a transaction amount;
sending a merchant code, the transaction amount, and an acquirer computer system identifier to a client computing device; and
receiving a notification from an acquirer computer system that a financial transaction for the transaction amount to pay for the goods and/or services with a financial account linked to the user has been authorized.
